(19) United States
(12) Patent Application Publication
(10) Pub. No.: US 2020/0128579 A1
(43) Pub. Date: Apr. 23, 2020

(54) CHANNEL DESIGN FOR ENHANCED MACHINE TYPE COMMUNICATION IN AN UNLICENSED SPECTRUM (eMTC-U) SYSTEM

(71) Applicant: Intel IP Corporation, Santa Clara, CA (US)

(72) Inventors: Salvatore Talarico, Sunnyvale, CA (US); Jinnian Zhang, Beijing (CN); Huaning Niu, San Jose, CA (US); Wenting Chang, Beijing (CN); Yu Huai, Beijing (CN)

(21) Appl. No.: 16/603,914

(22) PCT Filed: May 30, 2018
(86) PCT No.: PCT/US18/35213

§ 371 Date: Oct. 9, 2019

Related U.S. Application Data
(60) Provisional application No. 62/518,490, filed on Jun. 12, 2017.

(30) Foreign Application Priority Data
Jun. 13, 2017 (CN) PCT/CN2017/088099

(51) Int. Cl. H04W 72/12; H04W 4/70; H04W 16/14; H04L 5/00

(52) U.S. Cl. CPC H04W 72/1284; H04W 4/70; H04L 5/0057; H04L 5/0007; H04L 5/0055; H04W 16/14

(57) ABSTRACT

Technology for a user equipment (UE) operating in an enhanced Machine Type Communication (eMTC) in an unlicensed spectrum (eMTC-U) system is disclosed. The UE can identify uplink control information (UCI). The UE can encode the UCI for transmission to a Next Generation NodeB (gNB) in the eMTC-U system over a physical uplink control channel (PUCCH) in one physical resource block (PRB) in a subframe.

### BACKGROUND

Wireless systems typically include multiple User Equipment (UE) devices communicatively coupled to one or more Base Stations (BS). The one or more BSs may be Long Term Evolved (LTE) evolved NodeBs (eNB) or New Radio (NR) next generation NodeBs (gNB) that can be communicatively coupled to one or more UEs by a Third-Generation Partnership Project (3GPP) network.

Next generation wireless communication systems are expected to be a unified network/system that is targeted to meet vastly different and sometimes conflicting performance dimensions and services. New Radio Access Technology (RAT) is expected to support a broad range of use cases including Enhanced Mobile Broadband (eMBB), Massive Machine Type Communication (mMTC), Mission Critical Machine Type Communication (uMTC), and similar service types operating in frequency ranges up to 100 GHz.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates frequency hopping across different channels with non-contiguous repetitions over a channel in accordance with an example;

FIG. 2 is a table of supported physical uplink control channel (PUCCH) formats in a legacy Long Term Evolution (LTE) system in accordance with an example;

FIG. 3 is a table of a number of bits per subframe for different formats in a PUCCH in accordance with an example;

FIG. 4 illustrates a physical uplink control channel (PUCCH) that spans five subframes using an orthogonal cover code (OCC) in accordance with an example;

FIG. 5 is a table of TDD UL/DL configurations and corresponding maximum number of HARQ processes in accordance with an example;

FIG. 6 illustrates synchronized hybrid automatic repeat request (HARQ) feedback in accordance with an example;

FIG. 7 illustrates a non-synchronized physical uplink control channel (PUCCH) for a 60 millisecond (ms) downlink burst in accordance with an example;

FIG. 8 is a table of periodic channel quality indicator (CQI) and precoding matrix indicator (PMI) feedbacks in accordance with an example;

FIG. 9 depicts functionality of a user equipment (UE) operating in an enhanced Machine Type Communication (eMTC) in an unlicensed spectrum (eMTC-U) system in accordance with an example;

FIG. 10 depicts functionality of a user equipment (UE) operating in an enhanced Machine Type Communication (eMTC) in an unlicensed spectrum (eMTC-U) system in accordance with an example;

FIG. 11 depicts a flowchart of a machine readable storage medium having instructions embodied thereon for communicating over a physical uplink control channel (PUCCH) in an enhanced Machine Type Communication (eMTC) in an unlicensed spectrum (eMTC-U) system in accordance with an example;

FIG. 12 illustrates an architecture of a wireless network in accordance with an example;

FIG. 13 illustrates a diagram of a wireless device (e.g., UE) in accordance with an example;

FIG. 14 illustrates interfaces of baseband circuitry in accordance with an example; and

FIG. 15 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### Definitions

As used herein, the term “User Equipment (UE)” refers to a computing device capable of wireless digital communication such as a smart phone, a tablet computing device, a laptop computer, a multimedia device such as an iPod Touch®, or other type computing device that provides text or voice communication. The term “User Equipment (UE)” may also be referred to as a “mobile device,” “wireless device,” of “wireless mobile device.”

As used herein, the term “Base Station (BS)” includes “Base Transceiver Stations

(BTS),” “NodeBs,” “evolved NodeBs (eNodeB or eNB),” and/or “next generation NodeBs (gNodeB or gNB),” and refers to a device or configured node of a mobile phone network that communicates wirelessly with UEs.

As used herein, the term “cellular telephone network,” “4G cellular,” “Long Term Evolved (LTE),” “5G cellular” and/or “New Radio (NR)” refers to wireless broadband technology developed by the Third Generation Partnership Project (3GPP).

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

The present technology relates to Long Term Evolution (LTE) operation in an unlicensed spectrum in MulteFire (MF), and specifically to Internet of Things (IoT) operating in the unlicensed spectrum.

In one example, Internet of Things (IoT) is envisioned as a significantly important technology component, by enabling connectivity between many devices. IoT has wide applications in various scenarios, including smart cities, smart environment, smart agriculture, and smart health systems.

3GPP has standardized two designs to IoT services—enhanced Machine Type Communication (eMTC) and NarrowBand IoT (NB-IoT). As eMTC and NB-IoT UEs will be deployed in large numbers, lowering the cost of these UEs is a key enabler for the implementation of IoT. Also, low power consumption is desirable to extend the life time of the UE's battery.

With respect to LTE operation in the unlicensed spectrum, both Release 13 (Rel-13) eMTC and NB-IoT operates in a licensed spectrum. On the other hand, the scarcity of licensed spectrum in low frequency band results in a deficit in the data rate boost. Thus, there are emerging interests in the operation of LTE systems in unlicensed spectrum. Potential LTE operation in the unlicensed spectrum includes, but not limited to, Carrier Aggregation based licensed assisted access (LAA) or enhanced LAA (eLAA) systems, LTE operation in the unlicensed spectrum via dual connectivity (DC), and a standalone LTE system in the unlicensed spectrum, where LTE-based technology solely operates in the unlicensed spectrum without necessitating an “anchor” in licensed spectrum—a system that is referred to as MulteFire.

In one example, there are substantial use cases of devices deployed deep inside buildings, which would necessitate coverage enhancement in comparison to the defined LTE cell coverage footprint. In summary, eMTC and NB-IoT techniques are designed to ensure that the UEs have low cost, low power consumption and enhanced coverage.

To extend the benefits of LTE IoT designs into unlicensed spectrum, MulteFire 1.1 is expected to specify the design for Unlicensed-IoT (U-IoT) based on eMTC and/or NB-IoT. The unlicensed frequency band of current interest for NB-IoT or eMTC based U-IoT is the sub-1 GHz band and the ˜2.4 GHz band. In addition, similar approaches can be used for a NB-IoT based U-IoT design as well.

In one example, with respect to regulations in the unlicensed spectrum, the unlicensed frequency band of current interest is the 2.4 GHz band for U-IoT, which has spectrum with global availability. For global availability, designs are to abide by regulations in different regions, e.g. the regulations given by the Federal Communications Commission (FCC) in the United States and the regulations given by European Telecommunications Standards Institute (ETSI) in Europe. Based on these regulations, frequency hopping can be more appropriate than other forms of modulations, due to more relaxed power spectrum density (PSD) limitations and co-existence with other unlicensed band technologies, such as Bluetooth and Wifi. Specifically, frequency hopping has no PSD limit, whereas other wide band modulations have a PSD limit of 10 decibel-milliwatts per megahertz (dBm/MHz) in the regulations given by ETSI. The low PSD limit would result in limited coverage. Thus, the present technology focuses on the U-IoT with frequency hopping.

PUSCH Design for eMTC-U

In one configuration, a physical uplink shared channel (PUSCH) design for eMTC operating in unlicensed bands (eMTC-U) is described. In addition, a resource allocation design, coverage enhancement (CE) techniques for PUSCH U-IoT, and a modulation and coding scheme (MCS), transport block size (TBS) and hybrid automatic repeat request (HARQ) process are described.

In one example, in an eMTC system operating in licensed bands, the PUSCH can be designed to operate within 6 physical resource blocks (PRBs). Here, the design of the PUSCH for eMTC-U can use the design of the PUSCH for eMTC operating in the licensed band as a baseline.

In one configuration, with respect to the resource allocation, resource blocks (RBs) for the PUSCH can be pre-defined or indicated by higher layer signaling. As in legacy eMTC, a narrowband (NB) can comprise of 6 contiguous PRBs. A total number of NBs for an uplink (UL) can be given by └N_{RB}^{UL}/6┘, where N_{RB}^{UL} is a total number of PRBs dedicated for uplink.

In one example, the number of usable PRBs allowed in each of the operating system bands are as follows: For a system bandwidth (BW) of 1.4 MHz, N_{RB}^{UL} is equal to 6, for a system BW of 3 MHz, N_{RB}^{UL} is equal to 15, for a system BW of 5 MHz, N_{RB}^{UL} is equal to 25, for a system BW of 10 MHz, N_{RB}^{UL} is equal to 50, and for a system BW of 15 MHz, N_{RB}^{UL} is equal to 100.

In one example, the RBs can be grouped such that RBs in excess are located either at the center and/or at the both ends of the system BW. In one example, the NB can be formed by a different number of RBs, e.g., 1, 2 or 3 RBs. The RBs per NB can be non-contiguous, and in this case, an index of specific RBs forming a NB can be configured through higher layer signaling or can be pre-defined.

In one configuration, with respect to CE techniques, similar to legacy eMTC, coverage can be enhanced by repeating/bundling of the PUSCH across multiple UL subframes (SFs) (referred to as time repetitions). The number of repetitions can be indicated via an UL grant within downlink control information (DCI). A predefined set of repetitions can be used. The predefined set of PUSCH repetition number can be the same as in eMTC legacy: {1, 2, 4, 8, 16, 32, 64, 128, 192, 256, 384, 512, 768, 1024, 1536, 2048}. In one example, the predefined set of repetitions can be designed differently, or in alternative can be a subset of that of eMTC legacy. For example, different set of numbers of repetitions can be designed and indicated via a system information block (SIB). In addition, a maximum number of repetitions can be increased, or alternatively, the maximum number of repetitions can be reduced.

In one example, a PUSCH transport block can be mapped to a single SF and repeated using same or different redundancy versions (RVs). The RV sequence can be selected as for legacy eMTC and can be {0,2,3,1}, or it can be defined differently, e.g., {0,2}. In addition, an initial RV can be indicated within the DCI.

In one example, the repetitions of PUSCH across one or multiple UEs can occur over contiguous SFs. In another example, the PUSCH transmissions can be performed in a non-contiguous manner in portions of N contiguous SFs, where N is an integer and can be indicated via higher layer signaling. In one example, during an UL gap duration, corresponding PUSCH transmissions can be dropped. In addition, the UL gap is equal to N.

In one configuration, frequency hopping (FH) may not be supported, for example, when the bandwidth is narrowband. In this case, all repetitions can be within the channel, or otherwise can be dropped. In another configuration, frequency hopping can be supported for the physical channel. For example, FH can be performed across different NBs to realize frequency diversity. In another example, when FH is configured, the frequency hopping can occur between 2 or more NBs. FH can be indicated by DCI via higher layer signaling. The first narrowband can be statically configured or can be signaled through higher layer signaling. The other NBs can be determined using a configurable offset from the first NB. The offset can be either cell-specific or UE-specific.

In one example, FH can be applied to a same PRB location for a certain number of SFs Y_{CH}, which can be referred to as a “FH interval”, and the frequency location can be switched every Y_{CH} (or every Y channel). In another example, cross-subframe channel estimation can be enabled. The FH interval can be configured following a legacy eMTC design, or can assume different values. For instance, for CE mode A in FDD: Y_{CH}={1, 2, 4, 8}, while for TDD: Y_{CH}={1, 5, 10, 20}; for CE mode B in FDD: Y_{CH}={2, 4, 8, 16}, while for TDD: Y_{CH}={5, 10, 20, 40}. The FH interval can be configured in a cell-specific or UE-specific manner. Due to reduced bandwidth support, a bandwidth reduced low complexity (BL) UE can perform radio frequency (RF) retuning when switching NBs within the larger system bandwidth. In one example, for retuning, affected PUSCH symbols can be punctured. If retuning is mandatory for the PUSCH due to a sounding reference signal (SRS) transmission, the SRS can be dropped. In addition, the frequency hopping can be performed across different channels.

In one configuration, symbol-level combining can be supported. For example, data scrambling and RV cycling can be maintained for a set of Z SFs and can change only every Z UL SF. In one example, N=Z. In another example, Z can assume the same value as in legacy eMTC. In yet another example, Z can assume a lower value that that of legacy eMTC.

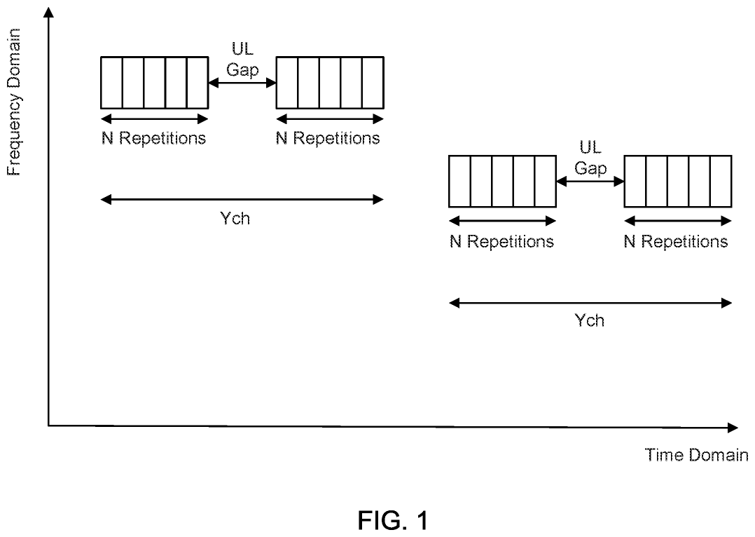

FIG. 1 illustrates an example of frequency hopping across different channels with non-contiguous repetitions over a channel. In this example, frequency hopping can be supported, and a PRB location can be changed every Y_{CH} SFs. Within each hop, the repetitions are not performed in a non-contiguous manner, and frequency hopping can be performed across different channels.

In one configuration, with respect to timing between an eMTC PDCCH (MPDCCH) and the PUSCH, the PUSCH starts from SF ‘n+k’ where ‘n’ is a last SF for MPDCCH repetitions, and k is determined as in eMTC legacy. For FDD, k is given by Table 8-2 in 3GPP TS 36.213; while for TDD, if the last SF for the MPDCCH repetitions does not have a corresponding PUSCH timing (k), the UE can assume a first DL/special SF, which can have a PUSCH timing after SF n as the last subframe of MPDCCH repetitions for PUSCH transmission. In addition, the offset k can be indicated in the DCI.

In one configuration, with respect to modulation, MCS, TBS and HARQ, the same MCS and TBS as in the legacy system can be maintained. In one example, a maximum TBS can be changed. As for legacy, for CE mode B, UE may not be expected to be scheduled with I_{MCS}>10. As for CE mode A, quadrature phase shift keying (QPSK) and 14 quadrature amplitude modulation (QAM) can be supported. In addition, with the aim to increase spectral efficiency, a higher modulation order can be supported.

In one example, the number of UL HARQ processes for BL UEs can be selected accordingly. For example, with respect to CE mode A, for half duplex frequency division duplex (HD-FDD) and FDD, no more than 8 HARQ processes for PUSCH can be allowed (same as in legacy LTE), while for TDD, the maximum number of HARQ processes for the PUSCH can be defined as in legacy LTE. As another example, with respect to CE mode B, for HD-FDD, full duplex FDD (FD-FDD), and time division duplex (TDD), no more than 2 HARQ processes can be allowed for the PUSCH.

In one example, the number of HARQ processes can be selected differently as compared to the legacy system. Similar to LTE legacy, the PUSCH can be asynchronous and adaptive. In one example, a retransmission of a new transport block (TB) can be indicated by toggling of a new data indicator (NDI) bit, and the UE can maintain in its transmission buffer the most recent TB until the NDI is toggled or a specific timer expires.

In one configuration, a design of an eMTC operating in an unlicensed band for a PUSCH is disclosed, including a resource allocation, CE techniques, a timing between the PUSCH and a MPUSCH, and other characteristics of the channel. In one example, RBs for the PUSCH can be pre-defined or indicated by higher layer signaling. In another example, as in legacy eMTC, a NB can comprise of 6 contiguous PRBs. In yet another example, the RBs can be grouped such that RBs in excess are located either at a center and/or at both ends of a system BW. In a further example, the NB can be formed by a different number of RBs, e.g., 1, 2 or 3 RBs. In yet a further example, the RBs per NB can be non-contiguous, and in this case, an index of specific RBs forming a NB can be configured through higher layer signaling or can be pre-defined.

In one example, similar to eMTC legacy, coverage can be enhanced by repeating/bundling of the PUSCH across multiple UL subframes (SFs). In another example, a number of repetitions can be indicated via an UL grant within a DCI. In yet another example, a predefined set of repetitions can be used. For example, the predefined set of PUSCH repetition number can the same as in eMTC legacy, or the predefined set of repetitions can be designed differently, e.g., the predefined set can be a subset of that of eMTC legacy. For example, a different set of numbers of repetitions can be designed and indicated via a SIB, or a maximum number of repetitions can be enlarged, or a maximum number of repetitions can be lowered.

In one example, a PUSCH transport block can be mapped to a single SF and repeated using same or different redundancy versions (RVs). In another example, repetitions of the PUSCH across one or multiple UEs can occur over contiguous SFs. In yet another example, PUSCH transmissions can be performed in a non-contiguous manner in tranches of N contiguous SFs, where N can be indicated via higher layer signaling. In a further example, during an UL gap duration, corresponding PUSCH transmissions can be dropped. In yet a further example, frequency hopping (FH) may not be supported, or alternatively, frequency hopping can be supported for the physical channel.

In one example, FH can be indicated by DCI via higher layer signaling. In another example, FH can be applied to the same PRB location for a certain number of SFs Y_{CH}, which can be referred to as a “FH interval”, and the frequency location can be switched every Y_{CH}. In yet another example, cross-subframe channel estimation can be enabled. In a further example, a BL UE can perform RF retuning when the BL UE switches NBs within a larger system bandwidth. In yet a further example, frequency hopping can be performed across different channels.

In one example, symbol-level combining can be supported. In another example, a PUSCH can start from SF ‘n+k’ where ‘n’ is a last SF for MPDCCH repetitions, and k can be determined as in eMTC legacy. In yet another example, the same MCS and TBS as legacy can be maintained. In a further example, a maximum TBS can be changed, and higher order modulation can be supported. In yet a further example, a number of UL HARQ processes for BL UEs can be selected as in eMTC legacy or using a different manner. In addition, a retransmission of a new TB can be indicated by toggling of a NDI bit, and the UE can maintain in its transmission buffer a most recent TB until the NDI is toggled or a specific timer expires.

PUCCH Design for eMTC-U

In one configuration, with respect to a PUCCH design for eMTC-U, in Release 13 (Rel-13) eMTC, the PUCCH can be designed within 6 RBs. The PUCCH formats 1/1a,2/2a can be supported for FDD and a UE configured with CE mode A, and the PUCCH formats 1/1a/1b, 2/2a/2b can be supported for TDD and a UE configured with CE mode A. The PUCCH formats 1/1a can be supported for CE mode B.

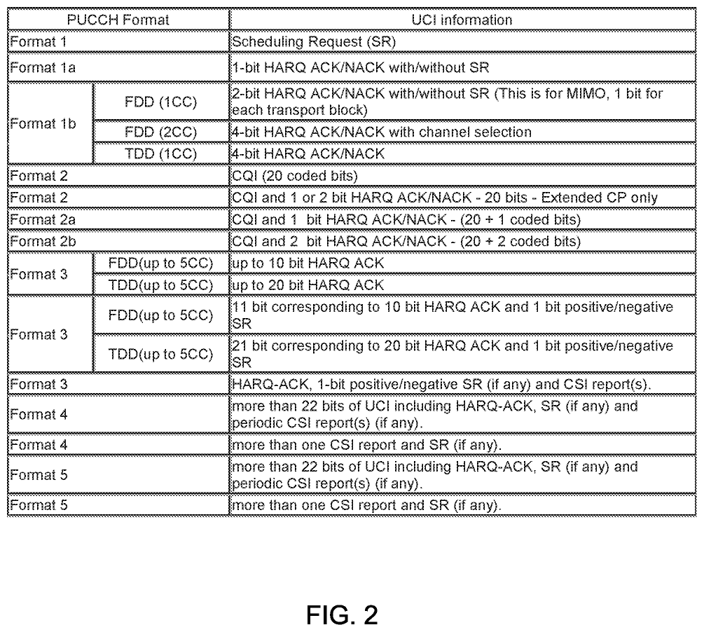

FIG. 2 is an example of a table of supported PUCCH formats in a legacy LTE system. For example, for PUCCH formats 1, 1a, 1b, 2, 2a, 2b, 3, 3, 4 and 5, corresponding uplink control information (UCI) can be defined. The UCI can include a scheduling request (SR), HARQ acknowledgement (ACK) or negative ACK (NACK), channel quality indication (CQI), channel state information (CSI) report, etc.

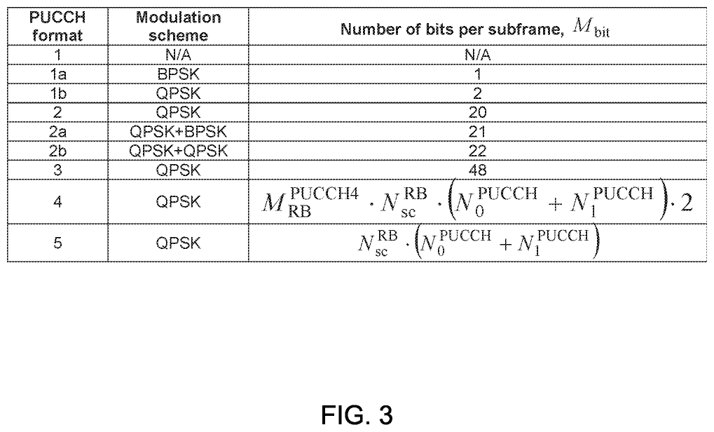

FIG. 3 is an example of a table of a number of bits per subframe for different formats in a PUCCH. For example, for PUCCH format 1, 1a, 1b, 2, 2a, 2b, 3, 4 and 4, a modulation can be defined (e.g., BPSK and/or QPSK) and a number of bits per subframe (M_{bit}) can be defined.

As described below, the control channel design for eMTC-U is defined, which can include a resource allocation, formats and content.

In one configuration, the PUCCH can be transmitted in either one PRB or multiple PRBs in the eMTC-U system for UCI transmission. When the PUCCH is transmitted in one PRB, the 1 PRB PUCCH can be within one subframe and one PRB, and can reuse a structure of: a format 1/1a/2/2a physical channel, as eMTC, a format 3/4/5 in one RB, an enhanced PUCCH (ePUCCH) that is scaled down to one RB configuration, or a shortened PUCCH (sPUCCH) that is extended to 1 subframe.

In one example, the PUCCH can span to multiple subframes by repetition or multiplying orthogonal cover codes (OCC), e.g., 5 subframes. The PUCCH can also be enabled to span more than five subframes, where x, e.g., 5 consecutive subframes+y, e.g., 5 off subframes+x consecutive subframes, and so on. In this example, x (the number of consecutive subframes) can be configured by an eNodeB through high layer signaling or can be set as 5 by default, and y (the number of off subframes) can be configured by the eNodeB through higher layer signaling or can be set as 5 by default.

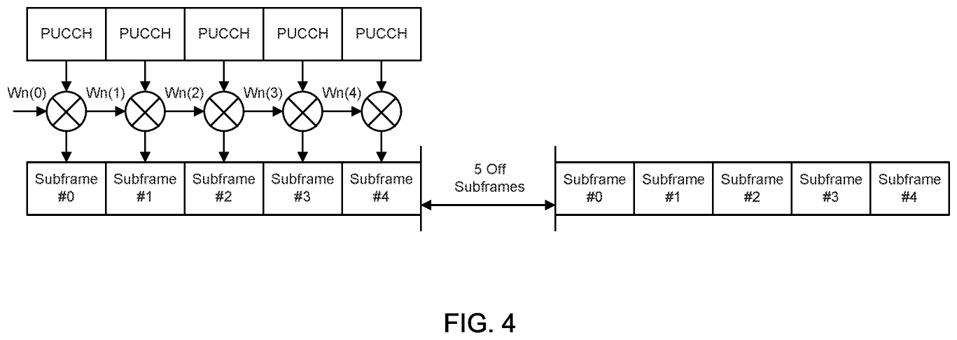

FIG. 4 illustrates an example of a PUCCH that spans five subframes using an OCC. In this example, the PUCCH can span five consecutive subframes, and then there can be five off subframes, and then the PUCCH can span another five consecutive subframes.

In one example, the OCC of different x subframes can be the same or different. When different, additional subframes can be jointed for OCC extension to support additional orthogonal PUCCH resources. In addition, within one channel, frequency hopping can be either enabled or not enabled, and diversity gain can be limited due to the narrowband system.

In one example, resources used for transmission formats 1/1a/1b, which can be represented by n_{PUCCH}^{(1,p̅)}, wherein p represents an antenna port index, can be either derived by a legacy formula or provided by higher layers. In another example, resources used for transmission formats 2/2a/2b, 3, 4, and 5, which can be represented by n_{PUCCH}^{(2,p̅)}, n_{PUCCH}^{(3,p̅)}, n_{PUCCH}⁽⁴⁾ and n_{PUCCH}⁽⁵⁾, respectively, can be provided by higher layers.

In one example, a subframe for the PUCCH can be transmitted within an association as the PDSCH, e.g., at a next subframe following a last downlink subframe. Alternatively, a periodicity, as well as a window can be configured, and the PUCCH can start to transmit at a first uplink subframe within the window.

In one example, the PUCCH can support one or more legacy formats according to the UCI information. For example, the PUCCH can use the legacy formats 1/1a/1b and 2/2a/2b to support a HARQ ACK/NACK transmission when periodic CQI transmission is not used in the uplink, and the PUCCH can use the legacy formats 3 to support a periodic CQI and HARQ ACK/NACK transmission

In one example, the PUCCH can be either constrained within one specific channel, or can span multiple channels. The PUCCH can be transmitted within valid UL subframes. When the PUCCH is constrained within one channel, remaining instants exceeding a maximum channel occupancy time (MCOT) of the channel can be dropped. When the PUCCH spans to multiple hopping channels, whether a next channel is acquired can be detected using presence signaling or cell-specific reference signal (CRS) detection firstly, and then the PUCCH transmission can continue.

In one configuration, when the PUCCH is transmitted using more than one PRB, the PUCCH can occupy more than one RB, e.g., 3 RBs or 6 RBs. The specific RBs for the PUCCH transmission can be configured by an eNodeB through high layer signaling. In one example, for format 1/1a, 2/2a, 3 and 5, the PUCCH can span to multiple RBs by repetition or multiplying OCC, and for format 4, the PUCCH can occupy multiple RBs by M_{RB}^{PUCCH4}, which can be providing from the higher layers. In one example, the ePUCCH and the sPUCCH can be scaled down to 3 RBs or 6 RBs.

In one example, the PUCCH can span to multiple subframes in the same way and support the same formats, as described in the above 1 RB case. In addition, the PUCCH can use the same timing resource and channels as in the above 1 RB case.

In one configuration, with respect to the content of the PUCCH, a maximum number of HARQ processes can reuse the configuration of 8 HARQ processes as in legacy FDD or HD-FDD, 16 HARQ processes as in MF 1.0, or up to 16 HARQ processes as in TDD.

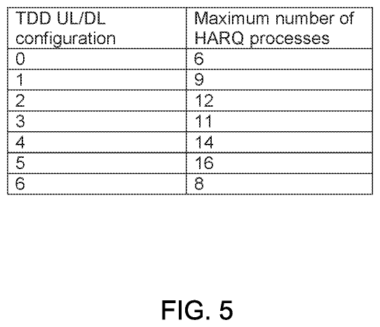

FIG. 5 is an example of a table of TDD UL/DL configurations and corresponding maximum number of HARQ processes. For a TDD UL/DL configuration of 0, 1, 2, 3, 4, 5 or 6, the maximum number of HARQ processes can be equal to 6, 9, 12, 11, 14, 16 or 8, respectively.

In one example, HARQ feedback can be synchronized or non-synchronized. For example, in a non-adaptive FH scheme, HARQ feedback can occur in a next UL subframe.

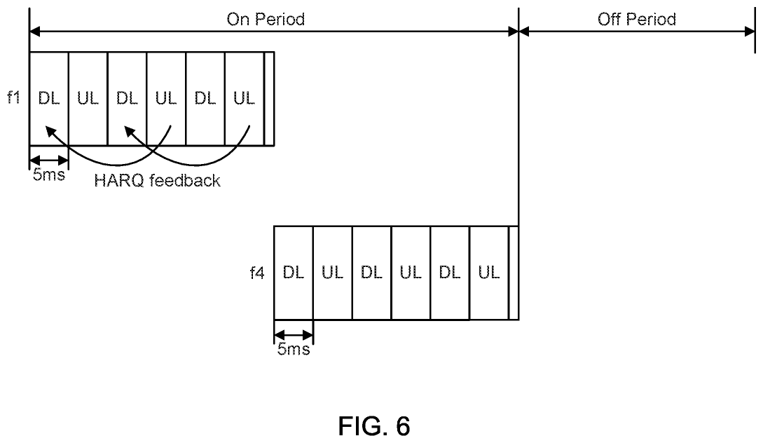

FIG. 6 illustrates an example of synchronized HARQ feedback. In this example, during an on period, HARQ feedback for a DL subframe can be transmitted on a next UL subframe (but not an immediately next UL subframe). In this example, the HARQ feedback for each DL subframe can be synchronized.

In one example, a duration of a DL burst can range from 0 ms to a maximum of either 40 or 60 ms, while 40 ms is for non-adaptive listen before talk (LBT), and 60 ms is for adaptive LBT. For example, within one MCOT, multiple downlink transmission can occur, e.g., 4 repetition MPDCCH plus 8 times PDSCH, and then a five downlink transmission can happen before an uplink transmission opportunity appears. In this case, the synchronized feedback may not work.

In one example, a non-synchronized PUCCH can be transmitted in UL subframes, since a downlink or uplink transmission opportunity at any given subframe is not available. For example, given m bits of HARQ feedback and an n DL transmission from an eNodeB in a HARQ window, the remaining (m-n) bits of the HARQ feedback can be ineffective, and can be ignored by the eNodeB. In addition, the DL/UL frame structures can be configured by the higher layers.

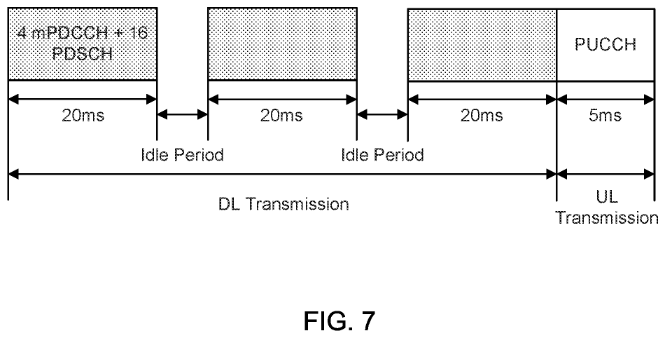

FIG. 7 illustrates an example of a non-synchronized PUCCH for a 60 ms DL burst. In this example, the non-synchronized PUCCH can be transmitted in UL subframes, since a downlink or uplink transmission opportunity at any given subframe is not available. The PUCCH can be transmitted for the 60 ms DL burst, which can be divided into multiple 20 ms DL periods with idle periods in between.

In one example, the PUCCH can support a HARQ, CQI, and SR transmission. For example, the PUCCH can support an N HARQ bitmap, where N can be a HARQ process number, and for each bit, ‘0’ represents NACK and ‘1’ represents ACK. In another example, the PUCCH can support periodic CQI and precoding matrix indicator (PMI) feedback, where in a first option, wideband CQI can be 4 bits, and in a second option, wideband CQI and PMI can be combined using a defined number of bits based on a certain number of antenna ports. In yet another example, the PUCCH can support the SR with a one-bit indicator, where ‘1’ represents a positive scheduling request and ‘0’ represents a positive scheduling request.

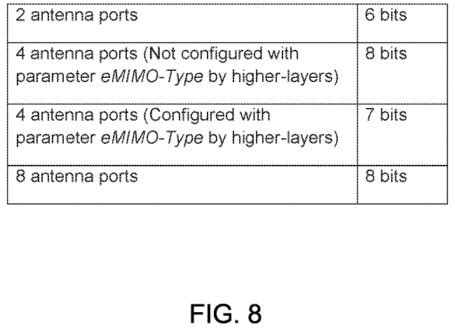

FIG. 8 is an example of a table of CQI/PMI feedbacks. The CQI/PMI feedback can include wideband CQI and PMI for a defined number of antenna ports (e.g., 2, 4 or 8 antenna ports), and the CQI/PMI feedback can correspond to a defined number of bits (e.g., 6, 7 or 8 bits) depending on the corresponding number of antenna ports.

In one example, PUCCH formats 1/1a/1b can support up to 2 information bits. The eNodeB can configure HARQ only using 1 bit, which can be multiplexed by TD or FD, and can be used in a specific PUCCH transmission. Alternatively, the eNodeB can configure HARQ and SR using 2 bits, which can be multiplexed by TD or FD, and can be used in a specific PUCCH transmission.

In one example, PUCCH formats 2/2a/2b can support up to 13 information bits. The eNodeB can configure HARQ only using 8 bits, which can be multiplexed by TD or FD, and can be used in a specific PUCCH transmission. In another example, the eNodeB can configure HARQ and SR using 9 bits, which can be multiplexed by TD or FD, and can be used in a specific PUCCH transmission. In another example, the eNodeB can configure HARQ and partial CQI using 12 bits, which can be multiplexed by TD or FD, and can be used in a specific PUCCH transmission. In another example, the eNodeB can configure HARQ and SR and partial CQI using 13 bits, which can be multiplexed by TD or FD, and can be used in a specific PUCCH transmission. In another example, the eNodeB can configure CQI using 11 bits, which can be multiplexed by TD or FD, and can be used in a specific PUCCH transmission. In addition, the PUCCH can support simultaneous transmission of HARQ, SR and CQI, which can be up to 20 bits.

In one configuration, a resource allocation is described for different formats of a PUCCH in an eMTC-U system. In one example, within one subframe and one RB, one of the following structures can be reused: format 1/1a/2/2a physical channel, as eMTC, format 3/4/5 in one RB, an ePUCCH that is scaled down to one RB configuration, or a sPUCCH that is extended to 1 subframe. In another example, the PUCCH can span to multiple subframes by repetition or multiplying OCC, e.g., 5 subframes. In yet another example, the PUCCH can be enabled to span on more than five subframes, where x, e.g., 5 consecutive subframes+y, e.g., 5 off subframes+x consecutive subframes, and so on, where x can be configured by an eNodeB through high layer signaling or set to ‘5’ by default.

In one example, the OCC of different x subframes can be the same or different. When different, additional subframes can be joined for OCC extension to support additional orthogonal PUCCH resources. In another example, within one channel, frequency hopping can be enabled or not enabled, and diversity gain can be limited due to the narrow band system. In yet another example, resources used for transmission formats 1/1a/1b, which can be represented by n_{PUCCH}^{(1,p̅)}, can be derived by a legacy formula or provided by higher layers. In a further example, resources used for transmission formats 2/2a/2b, 3, 4, and 5, which can be represented by n_{PUCCH}^{(2,p̅)}, n_{PUCCH}^{(3,p̅)}, n_{PUCCH}⁽⁴⁾ and n_{PUCCH}⁽⁵⁾, respectively, can be provided by higher layers.

In one example, the subframe for the PUCCH can be transmitted within an association as the PDSCH, e.g., at a next subframe following a last downlink subframe. Alternatively, the periodicity, as well as the window can be configured, and the PUCCH can start to transmit at the first uplink subframe within the window. In another example, the PUCCH can support one or more legacy formats according to UCI information. For example, the PUCCH can use the legacy formats 1/1a/1b and 2/2a/2b to support HARQ ACK/NACK transmission when periodic CQI transmission is not used in the uplink, and the PUCCH can use the legacy formats 3 to support a periodic CQI and HARQ ACK/NACK transmission. In yet another example, the PUCCH can be either constrained within one specific channel, or spanned to multiple channels. In a further example, the PUCCH can be transmitted within valid UL subframes. In yet a further example, when the PUCCH is constrained within one channel, remaining instants exceeding a MCOT of the channel can be dropped.

In one example, the PUCCH can span to multiple hopping channels, and whether a next channel is acquired can be detected using presence signaling or CRS detection firstly, and then the PUCCH transmission can continue. In another example, the PUCCH can occupy more than one RB, e.g., 3RBs or 6 RBs. The specific RBs for PUCCH transmission can be configured by an eNodeB through high layer signaling. In yet another example, for format 1/1a, 2/2a, 3 and 5, the PUCCH can span to multiple RBs by repetition or multiplying OCC. In a further example, for format 4, the PUCCH can occupy multiple RBs, which can be configured by the higher layers. In yet a further example, the ePUCCH and sPUCCH can be scaled down to 3 RBs or 6 RBs. In addition, the PUCCH can span to multiple subframes and support the same formats, as described in the 1 RB case, and the PUCCH can use the same timing resource and channels as in the 1 RB case.

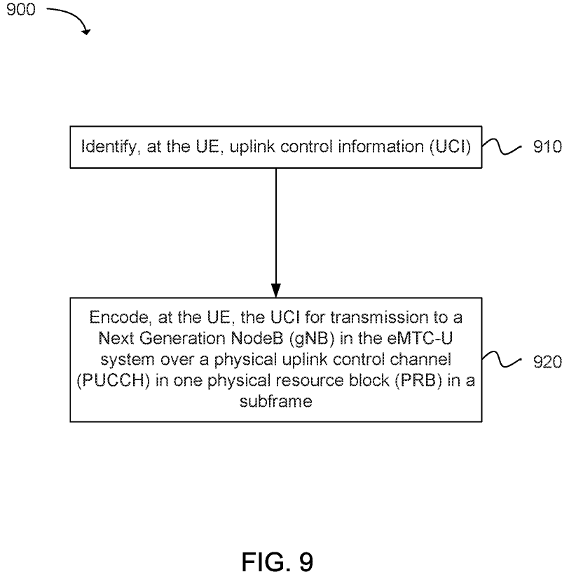

Another example provides functionality 900 of a user equipment (UE) operating in an enhanced Machine Type Communication (eMTC) in an unlicensed spectrum (eMTC-U) system, as shown in FIG. 9. The UE can comprise one or more processors configured to identify, at the UE, uplink control information (UCI), as in block 910. The UE can comprise one or more processors configured to encode, at the UE, the UCI for transmission to a Next Generation NodeB (gNB) in the eMTC-U system over a physical uplink control channel (PUCCH) in one physical resource block (PRB) in a subframe, as in block 920. In addition, the UE can comprise a memory interface configured to retrieve from a memory the UCI.

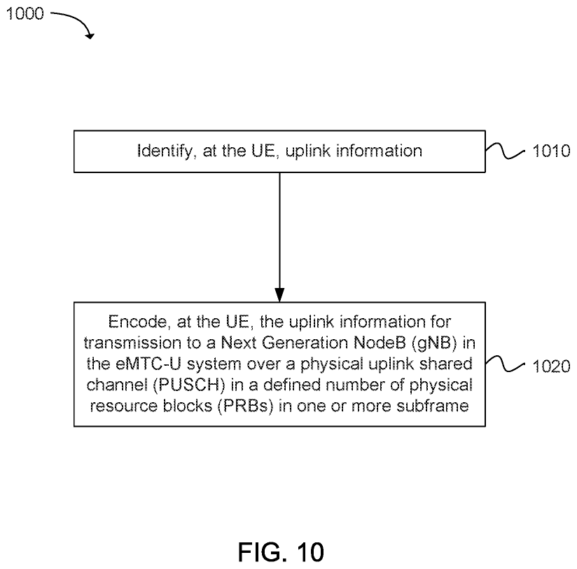

Another example provides functionality 1000 of a user equipment (UE) operating in an enhanced Machine Type Communication (eMTC) in an unlicensed spectrum (eMTC-U) system, as shown in FIG. 10. The UE can comprise one or more processors configured to identify, at the UE, uplink information, as in block 1010. The UE can comprise one or more processors configured to encode, at the UE, the uplink information for transmission to a Next Generation NodeB (gNB) in the eMTC-U system over a physical uplink shared channel (PUSCH) in a defined number of physical resource blocks (PRBs) in one or more subframe, as in block 1020. In addition, the UE can comprise a memory interface configured to retrieve from a memory the uplink information.

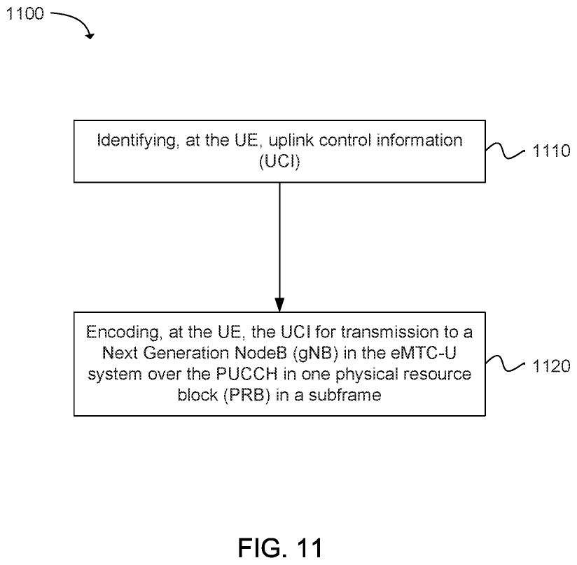

Another example provides at least one machine readable storage medium having instructions 1100 embodied thereon for communicating over a physical uplink control channel (PUCCH) in an enhanced Machine Type Communication (eMTC) in an unlicensed spectrum (eMTC-U) system, as shown in FIG. 11. The instructions can be executed on a machine, where the instructions are included on at least one computer readable medium or one non-transitory machine readable storage medium. The instructions when executed by one or more processors of a user equipment (UE) perform: identifying, at the UE, uplink control information (UCI), as in block 1110. The instructions when executed by one or more processors of a UE perform: encoding, at the UE, the UCI for transmission to a Next Generation NodeB (gNB) in the eMTC-U system over the PUCCH in one physical resource block (PRB) in a subframe, as in block 1120.

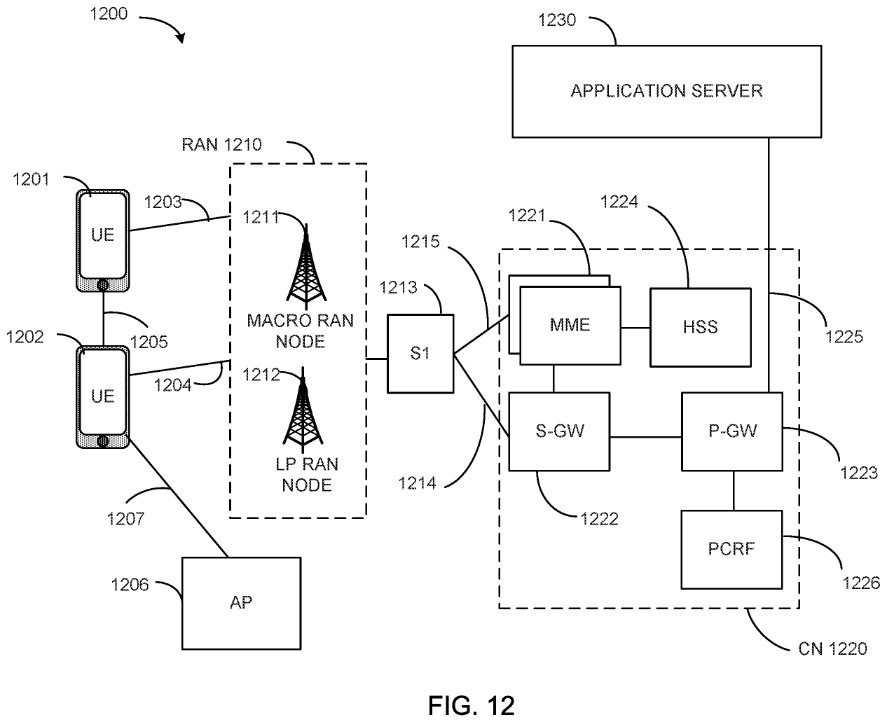

FIG. 12 illustrates an architecture of a system 1200 of a network in accordance with some embodiments. The system 1200 is shown to include a user equipment (UE) 1201 and a UE 1202. The UEs 1201 and 1202 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1201 and 1202 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 and 1202 may be configured to connect, e.g., communicatively couple, with a radio access network (RAN) 1210—the RAN 1210 may be, for example, an Evolved Universal Mobile Telecommunications System (UMTS) Terrestrial Radio Access Network (E-UTRAN), a NextGen RAN (NG RAN), or some other type of RAN. The UEs 1201 and 1202 utilize connections 1203 and 1204, respectively, each of which comprises a physical communications interface or layer (discussed in further detail below); in this example, the connections 1203 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1201 and 1202 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1202 is shown to be configured to access an access point (AP) 1206 via connection 1207. The connection 1207 can comprise a local wireless connection, such as a connection consistent with any IEEE 802.14 protocol, wherein the AP 1206 would comprise a wireless fidelity (WiFi®) router. In this example, the AP 1206 is shown to be connected to the Internet without connecting to the core network of the wireless system (described in further detail below).

The RAN 1210 can include one or more access nodes that enable the connections 1203 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1210 may include one or more RAN nodes for providing macrocells, e.g., macro RAN node 1211, and one or more RAN nodes for providing femtocells or picocells (e.g., cells having smaller coverage areas, smaller user capacity, or higher bandwidth compared to macrocells), e.g., low power (LP) RAN node 1212.

Any of the RAN nodes 1211 and 1212 can terminate the air interface protocol and can be the first point of contact for the UEs 1201 and 1202. In some embodiments, any of the RAN nodes 1211 and 1212 can fulfill various logical functions for the RAN 1210 including, but not limited to, radio network controller (RNC) functions such as radio bearer management, uplink and downlink dynamic radio resource management and data packet scheduling, and mobility management.

In accordance with some embodiments, the UEs 1201 and 1202 can be configured to communicate using Orthogonal Frequency-Division Multiplexing (OFDM) communication signals with each other or with any of the RAN nodes 1211 and 1212 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 and 1212 to the UEs 1201 and 1202, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 1201 and 1202. The physical downlink control channel (PDCCH) may carry information about the transport format and resource allocations related to the PDSCH channel, among other things. It may also inform the UEs 1201 and 1202 about the transport format, resource allocation, and H-ARQ (Hybrid Automatic Repeat Request) information related to the uplink shared channel. Typically, downlink scheduling (assigning control and shared channel resource blocks to the UE 1201 within a cell) may be performed at any of the RAN nodes 1211 and 1212 based on channel quality information fed back from any of the UEs 1201 and 1202. The downlink resource assignment information may be sent on the PDCCH used for (e.g., assigned to) each of the UEs 1201 and 1202.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 1210 is shown to be communicatively coupled to a core network (CN) 1220—via an S1 interface 1213. In embodiments, the CN 1220 may be an evolved packet core (EPC) network, a NextGen Packet Core (NPC) network, or some other type of CN. In this embodiment the S1 interface 1213 is split into two parts: the S1-U interface 1214, which carries traffic data between the RAN nodes 1211 and 1212 and the serving gateway (S-GW) 1222, and the S1-mobility management entity (MME) interface 1215, which is a signaling interface between the RAN nodes 1211 and 1212 and MMEs 1221.

In this embodiment, the CN 1220 comprises the MMEs 1221, the S-GW 1222, the Packet Data Network (PDN) Gateway (P-GW) 1223, and a home subscriber server (HSS) 1224. The MMEs 1221 may be similar in function to the control plane of legacy Serving General Packet Radio Service (GPRS) Support Nodes (SGSN). The MMEs 1221 may manage mobility aspects in access such as gateway selection and tracking area list management. The HSS 1224 may comprise a database for network users, including subscription-related information to support the network entities' handling of communication sessions. The CN 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the S1 interface 1213 towards the RAN 1210, and routes data packets between the RAN 1210 and the CN 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1223 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP communications interface 1225. The application server 1230 can also be configured to support one or more communication services (e.g., Voice-over-Internet Protocol (VoIP) sessions, PTT sessions, group communication sessions, social networking services, etc.) for the UEs 1201 and 1202 via the CN 1220.

The P-GW 1223 may further be a node for policy enforcement and charging data collection. Policy and Charging Enforcement Function (PCRF) 1226 is the policy and charging control element of the CN 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

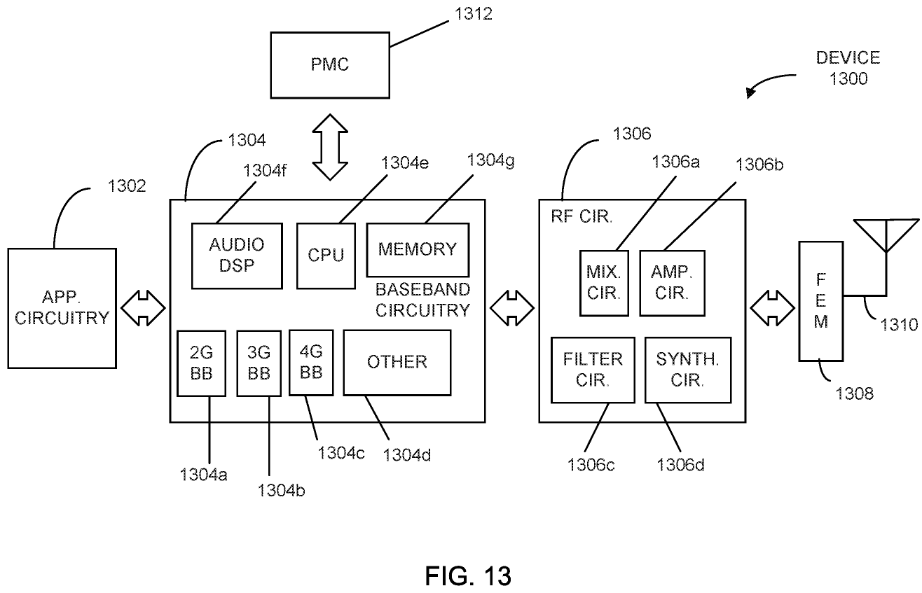

FIG. 13 illustrates example components of a device 1300 in accordance with some embodiments. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. Baseband processing circuity 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304a, a fourth generation (4G) baseband processor 1304b, a fifth generation (5G) baseband processor 1304c, or other baseband processor(s) 1304d for other existing generations, generations in development or to be developed in the future (e.g., second generation (2G), sixth generation (6G), etc.). The baseband circuitry 1304 (e.g., one or more of baseband processors 1304a-d) may handle various radio control functions that enable communication with one or more radio networks via the RF circuitry 1306. In other embodiments, some or all of the functionality of baseband processors 1304a-d may be included in modules stored in the memory 1304g and executed via a Central Processing Unit (CPU) 1304e. The radio control functions may include, but are not limited to, signal modulation/demodulation, encoding/decoding, radio frequency shifting, etc. In some embodiments, modulation/demodulation circuitry of the baseband circuitry 1304 may include Fast-Fourier Transform (FFT), precoding, or constellation mapping/demapping functionality.

In some embodiments, encoding/decoding circuitry of the baseband circuitry 1304 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304f. The audio DSP(s) 1304f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1304 and the application circuitry 1302 may be implemented together such as, for example, on a system on a chip (SOC).

In some embodiments, the baseband circuitry 1304 may provide for communication compatible with one or more radio technologies. For example, in some embodiments, the baseband circuitry 1304 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. RF circuitry 1306 may include a receive signal path which may include circuitry to down-convert RF signals received from the FEM circuitry 1308 and provide baseband signals to the baseband circuitry 1304. RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. RF circuitry 1306 may also include synthesizer circuitry 1306d for synthesizing a frequency for use by the mixer circuitry 1306a of the receive signal path and the transmit signal path. In some embodiments, the mixer circuitry 1306a of the receive signal path may be configured to down-convert RF signals received from the FEM circuitry 1308 based on the synthesized frequency provided by synthesizer circuitry 1306d. The amplifier circuitry 1306b may be configured to amplify the down-converted signals and the filter circuitry 1306c may be a low-pass filter (LPF) or band-pass filter (BPF) configured to remove unwanted signals from the down-converted signals to generate output baseband signals. Output baseband signals may be provided to the baseband circuitry 1304 for further processing. In some embodiments, the output baseband signals may be zero-frequency baseband signals, although this is not a necessity. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional N/N+1 synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may be configured to synthesize an output frequency for use by the mixer circuitry 1306a of the RF circuitry 1306 based on a frequency input and a divider control input. In some embodiments, the synthesizer circuitry 1306d may be a fractional N/N+1 synthesizer.

In some embodiments, frequency input may be provided by a voltage controlled oscillator (VCO), although that is not a necessity. Divider control input may be provided by either the baseband circuitry 1304 or the applications processor 1302 depending on the desired output frequency. In some embodiments, a divider control input (e.g., N) may be determined from a look-up table based on a channel indicated by the applications processor 1302.

Synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1306d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1306 may include an IQ/polar converter.

FEM circuitry 1308 may include a receive signal path which may include circuitry configured to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM 1308, or in both the RF circuitry 1306 and the FEM 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 13 12 may be additionally or alternatively coupled with, and perform similar power management operations for, other components such as, but not limited to, application circuitry 1302, RF circuitry 1306, or FEM 1308.

In some embodiments, the PMC 1312 may control, or otherwise be part of, various power saving mechanisms of the device 1300. For example, if the device 1300 is in an RRC Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC_Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1302 and processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1304 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

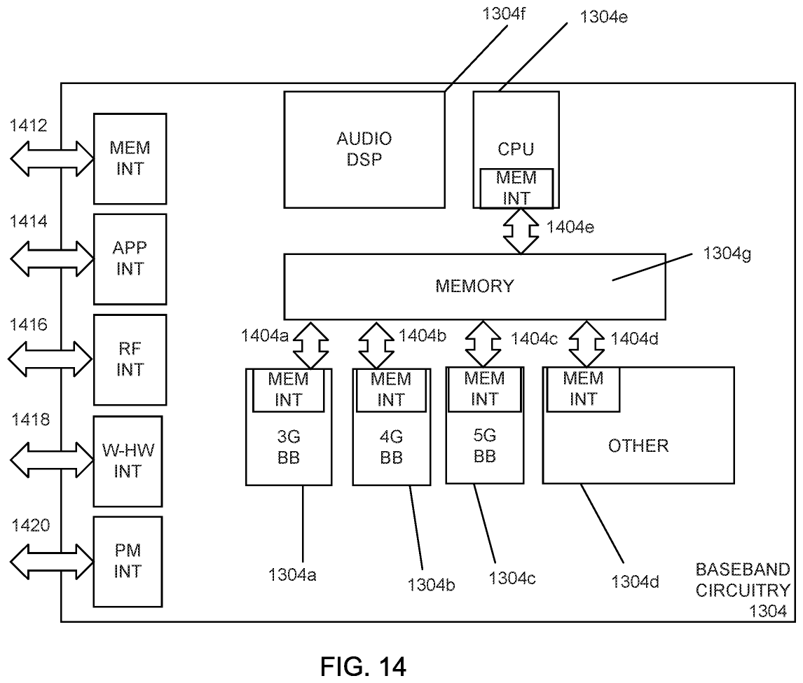

FIG. 14 illustrates example interfaces of baseband circuitry in accordance with some embodiments. As discussed above, the baseband circuitry 1304 of FIG. 13 may comprise processors 1304a-1304e and a memory 1304g utilized by said processors. Each of the processors 1304a-1304e may include a memory interface, 1404a-1404e, respectively, to send/receive data to/from the memory 1304g.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

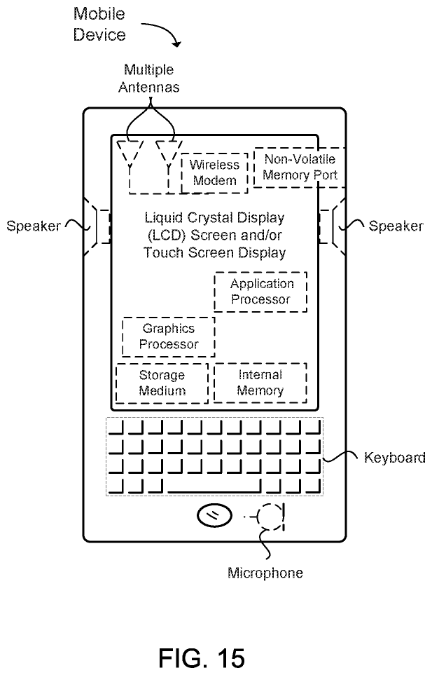

FIG. 15 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 15 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes an apparatus of a user equipment (UE) operating in an enhanced Machine Type Communication (eMTC) in an unlicensed spectrum (eMTC-U) system, the apparatus comprising: one or more processors configured to: identify, at the UE, uplink control information (UCI); and encode, at the UE, the UCI for transmission to a Next Generation NodeB (gNB) in the eMTC-U system over a physical uplink control channel (PUCCH) in one physical resource block (PRB) in a subframe; and a memory interface configured to retrieve from a memory the UCI.

Example 2 includes the apparatus of Example 1, further comprising a transceiver configured to transmit the UCI over the PUCCH to the gNB.

Example 3 includes the apparatus of any of Examples 1 to 2, wherein the PUCCH is in accordance with a format 1, 1a, 2, 2a or 3.

Example 4 includes the apparatus of any of Examples 1 to 3, wherein the PUCCH is an enhanced PUCCH (ePUCCH) that is scaled down to the one PRB in the subframe.

Example 5 includes the apparatus of any of Examples 1 to 4, wherein the one or more processors are further configured to encode multiple repetitions of the UCI for transmission to the gNB over the PUCCH in multiple subframes, wherein the UCI is included in one PRB for each repetition.

Example 6 includes the apparatus of any of Examples 1 to 5, wherein frequency hopping is not enabled for the PUCCH.

Example 7 includes the apparatus of any of Examples 1 to 6, wherein the one or more processors are further configured to decode higher layer signaling received from the gNB that indicates resources used for formats 1, 1a or 1b of the PUCCH, which are represented by n_{PUCCH}^{(1,p̅)}, wherein p represents an antenna port index.

Example 8 includes the apparatus of any of Examples 1 to 7, wherein the one or more processors are further configured to decode higher layer signaling received from the gNB that indicates resources used for formats 2, 2a or 3 of the PUCCH, which are represented by n_{pUCCH}^{(2,p̅)} and n_{PUCCH}^{(3,p̅)}, respectively, wherein p represents an antenna port index.

Example 9 includes the apparatus of any of Examples 1 to 8, wherein the one or more processors are further configured to: decode a configuration received from the gNB that includes a periodicity and a window of the PUCCH; and encode the UCI for transmission over the PUCCH starting from a first uplink subframe within the window and in accordance with the periodicity.

Example 10 includes the apparatus of any of Examples 1 to 9, wherein the PUCCH is constrained within one defined channel or is spanned to multiple channels.

Example 11 includes the apparatus of any of Examples 1 to 10, wherein the UCI includes non-synchronized hybrid automatic repeat request (HARQ) feedback.

Example 12 includes the apparatus of any of Examples 1 to 11, wherein: the PUCCH supports one or more of: a hybrid automatic repeat request (HARQ) transmission, a channel quality indicator (CQI) transmission and a scheduling request (SR) transmission; or the PUCCH supports a simultaneous transmission of the HARQ, the CQI and the SR.

Example 13 includes the apparatus of any of Examples 1 to 12, wherein the PUCCH supports one or more of: an N hybrid automatic repeat request (HARQ) bitmap, wherein N is a HARQ process number; periodic channel quality indicator (CQI) and precoding matrix indicator (PMI) feedback; or a one-bit scheduling request (SR) indicator, wherein: HARQ that comprises one bit is supported for PUCCH formats 1 or 1a; HARQ and SR that comprise two bits are supported for PUCCH formats 1 or 1a; or CQI that comprises 11 bits is supported for PUCCH formats 2 or 2a.

Example 14 includes an apparatus of a user equipment (UE) operating in an enhanced Machine Type Communication (eMTC) in an unlicensed spectrum (eMTC-U) system, the apparatus comprising: one or more processors configured to: identify, at the UE, uplink information; and encode, at the UE, the uplink information for transmission to a Next Generation NodeB (gNB) in the eMTC-U system over a physical uplink shared channel (PUSCH) in a defined number of physical resource blocks (PRBs) in one or more subframe; and a memory interface configured to retrieve from a memory the uplink information.

Example 15 includes the apparatus of Example 14, further comprising a transceiver configured to transmit the uplink information over the PUSCH to the gNB.

Example 16 includes the apparatus of any of Examples 14 to 15, wherein frequency hopping is not enabled for the PUSCH.

Example 17 includes the apparatus of any of Examples 14 to 16, wherein data scrambling and redundancy version (RV) cycling are maintained for a set of Z subframes (SFs) and change every Z uplink SFs, wherein Z is a positive integer.

Example 18 includes the apparatus of any of Examples 14 to 17, wherein the PUSCH starts from subframe (SF) ‘n+k’ where ‘n’ is a last SF for eMTC physical downlink control channel (MPDCCH) repetitions, and ‘k’ is indicated via downlink control information (DCI).

Example 19 includes at least one machine readable storage medium having instructions embodied thereon for communicating over a physical uplink control channel (PUCCH) in an enhanced Machine Type Communication (eMTC) in an unlicensed spectrum (eMTC-U) system, the instructions when executed by one or more processors at a user equipment (UE) perform the following: identifying, at the UE, uplink control information (UCI); and encoding, at the UE, the UCI for transmission to a Next Generation NodeB (gNB) in the eMTC-U system over the PUCCH in one physical resource block (PRB) in a subframe.

Example 20 includes the at least one machine readable storage medium of Example 19, wherein: the PUCCH is in accordance with a format 1, 1a, 2, 2a or 3; or the PUCCH is an enhanced PUCCH (ePUCCH) that is scaled down to the one PRB in the subframe; or frequency hopping is not enabled for the PUCCH; or the PUCCH is constrained within one defined channel or is spanned to multiple channels.

Example 21 includes the at least one machine readable storage medium of Examples 19 to 20, further comprising instructions when executed perform the following: encoding multiple repetitions of the UCI for transmission to the gNB over the PUCCH in multiple subframes, wherein the UCI is included in one PRB for each repetition; decoding higher layer signaling received from the gNB that indicates resources used for formats 1, 1a or 1b of the PUCCH, which are represented by n_{PUCCH}^{(1,p̅)}, wherein p represents an antenna port index; or decoding higher layer signaling received from the gNB that indicates resources used for formats 2, 2a or 3 of the PUCCH, which are represented by n_{pUCCH}^{(2,p̅)} and n_{PUCCH}^{(3,p̅)}, respectively.

Example 22 includes the at least one machine readable storage medium of Examples 19 to 21, further comprising instructions when executed perform the following: decoding a configuration received from the gNB that includes a periodicity and a window of the PUCCH; and encoding the UCI for transmission over the PUCCH starting from a first uplink subframe within the window and in accordance with the periodicity.

Example 23 includes the at least one machine readable storage medium of Examples 19 to 22, wherein: the UCI includes non-synchronized hybrid automatic repeat request (HARQ) feedback; or the PUCCH is a non-synchronized PUCCH for a downlink burst that is transmitted in an uplink subframe.

Example 24 includes the at least one machine readable storage medium of Examples 19 to 23, wherein: an N hybrid automatic repeat request (HARQ) bitmap, wherein N is a HARQ process number; periodic channel quality indicator (CQI) and precoding matrix indicator (PMI) feedback; or a one-bit scheduling request (SR) indicator, wherein: HARQ that comprises one bit is supported for PUCCH formats 1 or 1a; HARQ and SR that comprise two bits are supported for PUCCH formats 1 or 1a; or CQI that comprises 11 bits is supported for PUCCH formats 2 or 2a.

Example 25 includes a user equipment (UE) operable to communicate over a physical uplink control channel (PUCCH) in an enhanced Machine Type Communication (eMTC) in an unlicensed spectrum (eMTC-U) system, the UE comprising: means for identifying, at the UE, uplink control information (UCI); and means for encoding, at the UE, the UCI for transmission to a Next Generation NodeB (gNB) in the eMTC-U system over the PUCCH in one physical resource block (PRB) in a subframe.

Example 26 includes the UE of Example 25, wherein: the PUCCH is in accordance with a format 1, 1a, 2, 2a or 3; or the PUCCH is an enhanced PUCCH (ePUCCH) that is scaled down to the one PRB in the subframe; or frequency hopping is not enabled for the PUCCH; or the PUCCH is constrained within one defined channel or is spanned to multiple channels.

Example 27 includes the UE of any of Examples 25 to 26, further comprising: means for encoding multiple repetitions of the UCI for transmission to the gNB over the PUCCH in multiple subframes, wherein the UCI is included in one PRB for each repetition; means for decoding higher layer signaling received from the gNB that indicates resources used for formats 1, 1a or 1b of the PUCCH, which are represented by n_{PUCCH}^{(1,p̅)}, wherein p represents an antenna port index; or means for decoding higher layer signaling received from the gNB that indicates resources used for formats 2, 2a or 3 of the PUCCH, which are represented by n_{PUCCH}^{(2,p̅)} and n_{PUCCH}^{(3,p̅)}, respectively.

Example 28 includes the UE of any of Examples 25 to 27, further comprising: means for decoding a configuration received from the gNB that includes a periodicity and a window of the PUCCH; and means for encoding the UCI for transmission over the PUCCH starting from a first uplink subframe within the window and in accordance with the periodicity.

Example 29 includes the UE of any of Examples 25 to 28, wherein: the UCI includes non-synchronized hybrid automatic repeat request (HARQ) feedback; or the PUCCH is a non-synchronized PUCCH for a downlink burst that is transmitted in an uplink subframe.

Example 30 includes the UE of any of Examples 25 to 29, wherein: an N hybrid automatic repeat request (HARQ) bitmap, wherein N is a HARQ process number; periodic channel quality indicator (CQI) and precoding matrix indicator (PMI) feedback; or a one-bit scheduling request (SR) indicator, wherein: HARQ that comprises one bit is supported for PUCCH formats 1 or 1a; HARQ and SR that comprise two bits are supported for PUCCH formats 1 or 1a; or CQI that comprises 11 bits is supported for PUCCH formats 2 or 2a.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

What is claimed is:

1-24. (canceled)

25. An apparatus of a user equipment (UE) operable to communicate in a MulteFire (MF) bandwidth reduced low complexity and coverage enhancement (BL/CE) cell, the apparatus comprising:
one or more processors configured to:
identify, at the UE, uplink control information (UCI); and
encode, at the UE, the UCI for transmission to a base station in the MF BL/CE cell over a MF enhanced physical uplink control channel (MF-ePUCCH) in one physical resource block (PRB) in a subframe; and
a memory interface configured to retrieve from a memory the UCI.

26. The apparatus of claim 25, further comprising a transceiver configured to transmit the UCI over the MF-ePUCCH to the base station in the MF BL/CE cell.

27. The apparatus of claim 25, wherein the MF-ePUCCH is in accordance with a format 1, 1a, 2, 2a or 3.

28. The apparatus of claim 25, wherein the one or more processors are further configured to communicate over a Machine Type Communication PUCCH (MPUCCH), wherein frequency hopping is not enabled for the MPUCCH.

29. The apparatus of claim 25, wherein the one or more processors are further configured to decode higher layer signaling received from the base station that indicates resources used for formats 1, 1a or 1b of the MF-ePUCCH, which are represented by n_{PUCCH}^{(1,p̅)}, wherein p represents an antenna port index.

30. The apparatus of claim 25, wherein the one or more processors are further configured to decode higher layer signaling received from the base station that indicates resources used for formats 2, 2a or 3 of the MF-ePUCCH, which are represented by n_{PUCCH}^{(2,p̅)} and n_{PUCCH}^{(3,p̅)}, respectively, wherein p represents an antenna port index.

31. The apparatus of claim 25, wherein the MF-ePUCCH supports a hybrid automatic repeat request (HARD) transmission, a channel quality indicator (CQI) transmission and a scheduling request (SR) transmission.

32. An apparatus of a base station operating in an enhanced Machine Type Communication (eMTC) in an unlicensed spectrum (eMTC-U) system, the apparatus comprising:
one or more processors configured to:
decode, at the base station, uplink control information received from a user equipment (UE) in the eMTC-U system over a physical uplink shared channel (PUSCH) in a defined number of physical resource blocks (PRBs) in one or more subframe; and
a memory interface configured to send to a memory the uplink control information.

33. The apparatus of claim 32, wherein frequency hopping is not enabled for the PUSCH.

34. The apparatus of claim 32, wherein data scrambling and redundancy version (RV) cycling are maintained for a set of Z subframes (SFs) and change every Z uplink SFs, wherein Z is a positive integer.

35. The apparatus of claim 32, wherein the PUSCH starts from subframe (SF) ‘n+k’ where ‘n’ is a last SF for eMTC physical downlink control channel (MPDCCH) repetitions, and ‘k’ is indicated via downlink control information (DCI).

36. At least one non-transitory machine readable storage medium having instructions embodied thereon for communicating over a physical uplink control channel (PUCCH) in an enhanced Machine Type Communication (eMTC) in an unlicensed spectrum (eMTC-U) system, the instructions when executed by one or more processors at a user equipment (UE) perform the following:
identifying, at the UE, uplink control information (UCI); and
encoding, at the UE, the UCI for transmission to a Next Generation NodeB (gNB) in the eMTC-U system over a physical uplink control channel (PUCCH) in one physical resource block (PRB) in a subframe.

37. The at least one non-transitory machine readable storage medium of claim 36, wherein the PUCCH is in accordance with a format 1, 1a, 2, 2a or 3.

38. The at least one non-transitory machine readable storage medium of claim 36, wherein the PUCCH is an enhanced PUCCH (ePUCCH) that is scaled down to the one PRB in the subframe.

39. The at least one non-transitory machine readable storage medium of claim 36, further comprising instructions when executed perform the following: encoding multiple repetitions of the UCI for transmission to the gNB over the PUCCH in multiple subframes, wherein the UCI is included in one PRB for each repetition.

40. The at least one non-transitory machine readable storage medium of claim 36, wherein frequency hopping is not enabled for the PUCCH.

41. The at least one non-transitory machine readable storage medium of claim 36, further comprising instructions when executed perform the following: decoding higher layer signaling received from the gNB that indicates resources used for formats 1, 1a or 1b of the PUCCH, which are represented by n_{PUCCH}^{(1,p̅)}, wherein p represents an antenna port index.

42. The at least one non-transitory machine readable storage medium of claim 36, further comprising instructions when executed perform the following: decoding higher layer signaling received from the gNB that indicates resources used for formats 2, 2a or 3 of the PUCCH, which are represented by n_{PUCCH}^{(2,p̅)} and n_{PUCCH}^{(3,p̅)}, respectively, wherein p represents an antenna port index.

43. The at least one non-transitory machine readable storage medium of claim 36, further comprising instructions when executed perform the following:
decoding a configuration received from the gNB that includes a periodicity and a window of the PUCCH; and
encoding the UCI for transmission over the PUCCH starting from a first uplink subframe within the window and in accordance with the periodicity.

44. The at least one non-transitory machine readable storage medium of claim 36, wherein the PUCCH is constrained within one defined channel or is spanned to multiple channels.

45. The at least one non-transitory machine readable storage medium of claim 36, wherein the UCI includes non-synchronized hybrid automatic repeat request (HARQ) feedback.

46. The at least one non-transitory machine readable storage medium of claim 36, wherein:
the PUCCH supports one or more of: a hybrid automatic repeat request (HARQ) transmission, a channel quality indicator (CQI) transmission and a scheduling request (SR) transmission; or
the PUCCH supports a simultaneous transmission of the HARQ, the CQI and the SR.

47. The at least one non-transitory machine readable storage medium of claim 36, wherein the PUCCH supports one or more of:
an N hybrid automatic repeat request (HARQ) bitmap, wherein N is a HARQ process number;
periodic channel quality indicator (CQI) and precoding matrix indicator (PMI) feedback; or
a one-bit scheduling request (SR) indicator,
wherein:
HARQ that comprises one bit is supported for PUCCH formats 1 or 1a;
HARQ and SR that comprise two bits are supported for PUCCH formats 1 or 1a; or
CQI that comprises 11 bits is supported for PUCCH formats 2 or 2a.
